(19) United States
(12) Patent Application Publication
(10) Pub. No.: US 2016/0196500 A1
(43) Pub. Date: Jul. 7, 2016

(54) COMPUTER IMPLEMENTED FRAMEWORKS AND METHODOLOGIES FOR ENABLING RISK ANALYSIS FOR A SYSTEM COMPRISING PHYSICAL ASSETS

(71) Applicant: CLIMATE RISK PTY LTD, Sydney, New South Wales (AU)

(72) Inventors: Karl Mallon, Sydney (AU); Shane Brown, Sydney (AU)

(21) Appl. No.: 14/392,296

(22) PCT Filed: Jun. 26, 2014
(86) PCT No.: PCT/AU14/00668

§ 371 Date: Dec. 23, 2015

(30) Foreign Application Priority Data
Jun. 26, 2013 (AU) 2013902354

(51) Int. Cl. G06N 7/00; G06F 11/30; G06F 11/34

(52) U.S. Cl. CPC G06N 7/005; G06F 11/3409; G06F 11/3024

(57) ABSTRACT

Described herein are computer implemented frameworks and methodologies for enabling risk analysis (and in some cases resilience testing) for a system comprising physical assets. This may include use of a disaggregation/re-aggregation methodology thereby to understand risks based on engineering parameters underlying assets. Some embodiments take into particular consideration risks that evolve over time due to changes in climate and other external or internal scenarios. While some embodiments will be described herein with particular reference to such applications, it will be appreciated that the invention is not limited to such a field of use, and is applicable in broader contexts.

### FIELD OF THE INVENTION

The present invention relates to computer implemented frameworks and methodologies for enabling risk analysis (and in some cases resilience testing) for a system comprising physical assets. Embodiments of the invention have been particularly developed for analysis of environmental risks, such as floods, fires, and the like. Some embodiments take into particular consideration risks that evolve over time due to changes in climate and other external or internal scenarios. While some embodiments will be described herein with particular reference to such applications, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Computer implemented risk analysis tools have in recent times become widely used across a number of fields. However, many of these tools suffer from significant shortcomings, for example in terms of limited flexibility and/or scalability, rigid data constraints, and time-intensive and labour intensive processing. There is a need in the art for improved computer implemented frameworks and methodologies for enabling more sophisticated and more extensive risk analysis.

### SUMMARY OF THE INVENTION

It is an object of the present invention to overcome or ameliorate at least one of the disadvantages of the prior art, or to provide a useful alternative.

One embodiment provides a computer implemented method for performing risk analysis for a system including'a plurality of physical assets, the method including:

for each asset, defining an asset data item;

for each asset data item, defining one or more element data items respectively indicative of elements that constitute the asset;

for each element data item, defining one or more engineering-level data items respectively indicative of materials and components that constitute the element;

disaggregating each asset data item into its constitute element data items, and each element data item into its engineering-level data items;

operating a risk assessment engine thereby to determine risk quantifiers for each of the engineering-level data items based on a set of engineering data parameters and a set of future conditions parameters; and

upwardly aggregating the determined risk quantifiers thereby to determine risk quantifiers for the elements, and upwardly aggregating the risk quantifiers for the elements thereby to determine risk quantifiers for the assets.

One embodiment provides a computer implemented method for performing risk analysis for a system including a plurality of physical assets, the method including:

providing an interface for enabling creation of asset data items for each physical asset wherein each data item is defined by a set of attributes describing the asset;

in respect of a given data item:

(i) enabling the user to input current attributes for the asset data item;

(ii) enabling the user to input a future date; and

(iii) enabling the user to input future attributes for the asset data item for the future data, wherein one or more of the future attributes are different from one or more of the current attributes; and

operating a risk assessment engine thereby to perform a risk assessment for the system, wherein the risk assessment takes into consideration the attributes for each asset data item and a set of future conditions parameters;

wherein the risk assessment is for a time period including the future date, and wherein for the given data item the risk assessment is based upon the current attributes for a time period preceding the future date, and based upon the future attributes for a time period following the future date.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being !imitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 schematically illustrates an arrangement according to one embodiment.

FIG. 2A illustrates a method according to one embodiment.

FIG. 2B illustrates a method according to one embodiment.

FIG. 3 illustrates a client-server framework leveraged by various embodiments.

### DETAILED DESCRIPTION

Described herein are computer implemented frameworks and methodologies for enabling risk analysis for a system comprising a plurality of physical assets, hazards and times steps. Embodiments of the invention have been particularly developed for analysis of environmental risks, such as floods, fires, and the like. Some embodiments take into particular consideration risks, which evolve with time such as changes in. While some embodiments will be described herein with particular reference to such applications, it will be appreciated that the invention is not limited to such a field of use, and is applicable in broader contexts.

### Overview

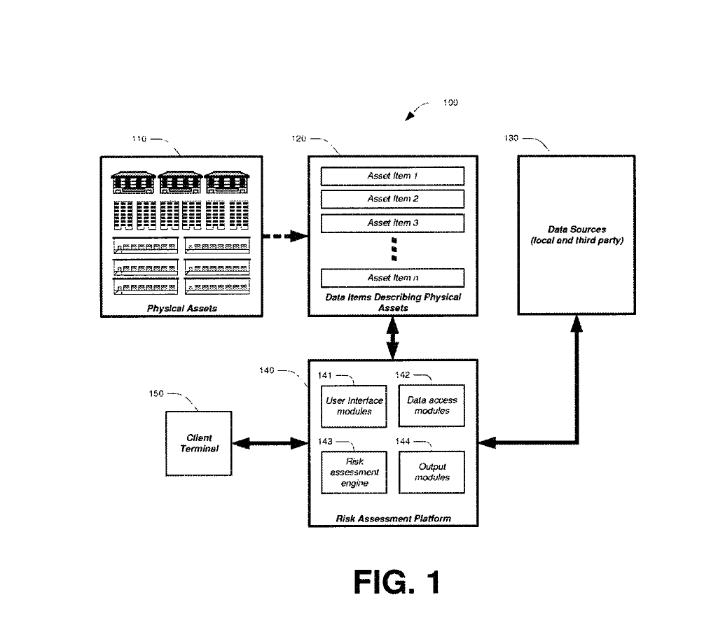

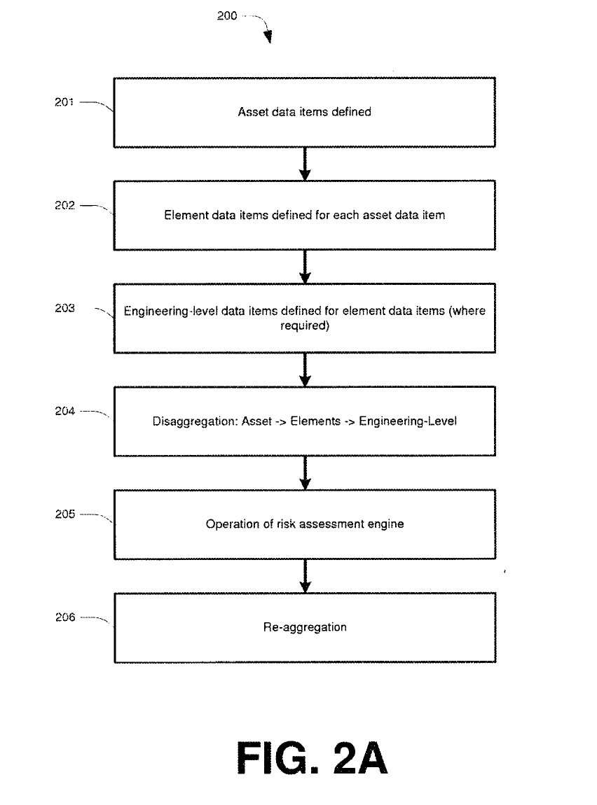

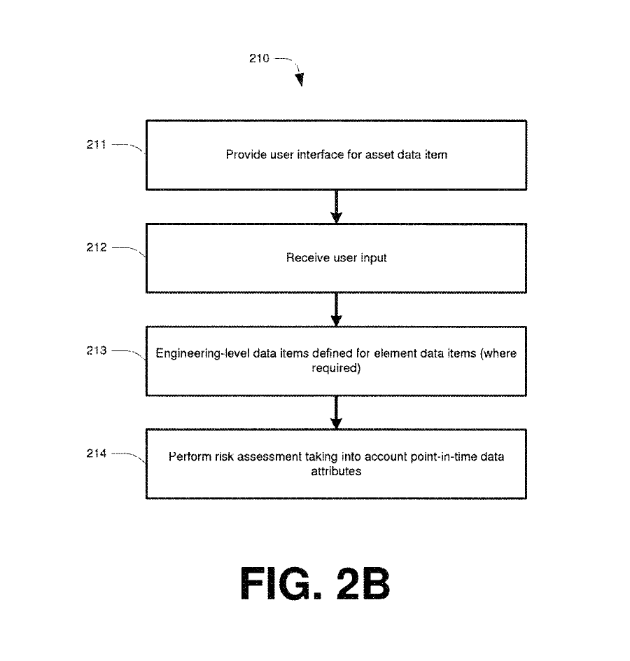

FIG. 1 illustrates an arrangement 100 according to one embodiment. In overview, arrangement 100 is intended to provide context of various technologies and methodologies described herein, particularly by reference to FIG. 2A to FIG. 2C. These technologies and methodologies are provided with further detailed context by way more detailed embodiments described further below.

In overview, the embodiment of FIG. 1 relates to risk analysis (also referred to herein as risk assessment) for a system including a plurality of physical assets 110, which may include substantially any physical assets (such as buildings, machinery, infrastructure, facilities, and so on). Physical assets 110 are described, in an information system 120, by “data items”. For example, a data item may be defined by a collection of associated data in a computer system, for example in the context of a database, matrix, or the like. Additional data sources (which may include both local data sources and third party sources) are also used, these providing the likes of spatial information, hazard information, climate predictive data, and so on.

A risk assessment platform 140, which may be defined by one or more computer program products defined by computer executable code, executes on a server device (or in some cases across a plurality of server devices). A client terminal 150 interacts with platform 140, for example by downloading HTML (and other code) from user interface modules 141, for rendering in a local browser, thereby to provide a local interface by which a user of client terminal 150 may interact with platform 140. For example, such interactions may relate to purposes including (but not limited to) adding/modifying data items, conducting risk analysis and/or modelling, defining modelling scenarios, adjusting analysis parameters, testing the effects of changed asset defining data items, machine-machine interaction, and so on.

Platform 140 provides for the use of data from archetypes, data dictionaries and prefilling matrices drawing from standardised national or international data on certain asset types, designs and materials performance.

Platform 140 includes data access modules 142, which are configured for interacting with data items 120 and data sources 130. In some embodiments modules 142 are configured to normalise (and/or otherwise “ensure operational integrity”) data obtained from third party data sources thereby to enable that data to comply with predefined local standards.

A risk assessment engine 143 is configured for performing risk analysis using data items 120 and data sources 130. For example, engine 143 may be configured to operating a risk assessment engine thereby to determine risk quantifiers for a physical asset, its elements and sub-elements based on a set of future conditions parameters (and optionally other modelling parameters and/or constraints).

### Disaggregation and Aggregation

FIG. 2A illustrates a method 200 according to one embodiment, being a computer implemented method for performing risk analysis for a system including a plurality of physical assets. For example, this method may be performed by platform 140 in respect of assets 110.

Functional block 201 represents a process including, for each asset, defining an asset data item. For example this may occur during initial configuration. In some embodiments a suite of standardised asset types are defined, thereby to streamline this process. That is, data items having respective sets of data attribute fields are predefined for each form of asset, and these data attribute fields are then populated based on a particular implementation (archetypes).

Functional block 202 represents a process including, for each asset data item, defining one or more element data items respectively indicative of elements that constitute the asset. For example, these may include civil, electrical, mechanical, electronic, chemical, biological, and ecological elements that make up a particular asset. Again, these may be defined with assistance of a suite of predefined standard elements for a standard asset type. These are variable based on configuration of the system for example building versus water. In some cases tiers of element data items are used (for example data items and sub-items).

Functional block 203 represents a process including, for all or a selection of the element data items, defining engineering-level data items. Again, these may be defined with assistance of a suite of predefined standard elements for the archetype. In this manner, an asset may be disaggregated into its constituent elements (and optionally sub-elements), which are then ultimately able to be disaggregated into engineering-level data items for which had scientific engineering data (such as tolerances, design envelopes, and the like) are objectively defined.

Each engineering-level data item type can be assessed by reference to engineering data parameters, which provide data regarding tolerances ranges to each hazard, such as heat, sensitivity to water and/or other hazards, design envelopes (for example operating ranges) and the like.

In some cases an engineering-level data item represents a material that constitutes the element (for example plastics, concrete, steel, etc.). For example, a concrete pipe element may have “concrete” defined as a materials data item. In such cases, the engineering data parameters are indicative of performance of a given material under predefined conditions. In other cases an engineering-level data item represents a complex component (for example a structural component, mechanical component, electrical component, or combination of two or more of a structural component, mechanical component, and electrical component, where the operating properties are defined by factors above and beyond properties of the individual constituent materials), and the engineering data parameters are indicative of a design envelope representing performance of a given component under predefined conditions. For example, a design envelope may be defined for a certain form of roofing structure, a computer, an engine, or the like.

Functional block 204 represents a process including disaggregating each asset data item into constitute element data items, and each element data item into its engineering-level data items. Following this, functional block 205 represents a process including operating the risk assessment engine thereby to determine risk quantifiers for each of the engineering-level data items based on a set of engineering data parameters and a set of future conditions parameters regarding the probability of hazard occurrence. Functional block 206 represents a process including upwardly aggregating the determined risk quantifiers thereby to determine risk quantifiers for the elements, and upwardly aggregating the risk quantifiers for the elements thereby to determine risk quantifiers for the assets for that set of conditions, year, settings and assets etc.

By breaking a given asset down into elements, sub-elements and engineering-level components, framework 140 is enabled to perform a bottom-up risk analysis based on industry standard scientific and engineering data (for example relating to materials properties or component design envelopes). That is, where a hazard is assessed, the impact of that particular hazard can be determined in terms of the impact on specific materials/components that are present. Accordingly, risk assessment is substantively objectified based on scientific engineering data relating to the actual properties and tolerances of materials and components that make up assets in the system.

In some embodiments, to determine the exposure of an asset to a hazard, a method includes first disaggregating the asset into elements based on their function. For example, this may in some cases use standardised asset elements. In one embodiment the following twelve are used: civil, electrical, mechanical, electronic, chemical, biological, ecological, and additional external system elements: power, information (data links), water, and access (e.g., roads) and “other”. Each asset is analysed for the presence of each of these elements, and the result is expressed in binary form in a matrix.

Rather than assuming that the asset as a whole and all its elements are exposed to a given hazard, some embodiments make use of an Element Exposure Matrix that catalogues which asset elements (e.g. civil, electrical, mechanical, power, etc.) are exposed to which hazards. For example, in one embodiment the following hazards are considered:

| Climate change driver | Climate hazard | Description |
|---|---|---|
| Sea level rise | Coastal inundation | Inundation of assets due to flooding from high |
| | | sea events driven by increased mean sea levels |
| | | and storm surge |
| Precipitation | Riverine flooding | Inundation of assets due to surface flows and |
| | | increased river heights during high precipitation |
| | | events. |
| Wind | Extreme wind | Extreme wind gusts that exceed the design |
| | | standard of structures. |
| Temperature | Heatwave | High ambient temperature event that may |
| | | exceed the design specification of structures or |
| | | equipment. |
| Temperature | Bushfire | Fire event in grassland or forest which includes |
| | | temperatures consistent with direct flame |
| | | exposure. |

This avoids the need for testing elements which are either not directly exposed to a hazard or are protected by other elements. For example, although for a sewerage pumping station in a bushfire zone, the pump itself (the ‘mechanical element’) is not directly exposed to bushfire, as it is eight metres underground, however the above ground power connection for this pump (the ‘power element’) would be directly exposed to bushfire. The Element Exposure Matrix stores this information using a binary system, assigning a 0 (not exposed) to the ‘mechanical element’ and a 1 (exposed) to the ‘power element’, if more sophisticated data on historical exposure rates is available, a fractional probability value between 0 and 1 can also be used.

Element Exposure Matrices are in some embodiments based on professional analysis of ‘as constructed’ drawings of each asset subclass, and information from external sources. The Exposure Coefficient for an asset element is drawn from the Element Exposure Matrix for an asset subclass. This coefficient is a binary variable that indicates either that this element will be exposed to the hazard event, or that it is protected by other elements or unexposed for some other reason. For example the civil structures of a submersible pumping station may be subjected to extreme temperatures but the submerged pump will not. Thus the Exposure Coefficient of the civil element would be 1 (exposed), and the mechanical element 0 (not exposed). Non-binary forms of the Exposure Coefficient are possible if empirical data on exposure is available.

Relationships between materials and hazard driven failure are in some embodiments constructed via Material Failure Coefficients. The Material Failure Coefficient (MFC) for a given material and hazard is the probability that the element using this material will fail when exposed to a specified hazard event. A Material Performance Database is a catalogue of the MFCs that are used to test element materials against the hazards to which they are exposed.

The MFCs used in various embodiments may be derived using many different methods that included:
Empirical data from historical experience was used to establish a mathematical relationship.
Probability distribution of hazards and material relationships. Extrapolation of known relationship for equivalent materials.
Standard engineering parameters for materials that can be used to predict a materials performance to different hazards.
The use of design proxies that build on the design specifications of an asset to infer the failure thresholds of the materials.

It should be noted that in other cases it is not possible to directly infer the probability of failure. Instead a range of material response can be used to create a MFC for a given material. For example, where structural failure is concerned, Ultimate Strength clearly quantifies material strength. However, the actual risk of failure is affected by thickness and design. Therefore, the MFC for structural failure should in some cases be complemented by other information about the asset such as rated design performance to a hazard.

For other materials and hazards the impacts are not as clearly defined. In these cases MFCs were derived from probability distributions of hazards and material relationships, analysis of historical trends, or industry expertise. For example, the ability of a material to withstand a bushfire depends on the heat intensity of the bushfire; for a projected future this can only be estimated using a probability distribution. Similarly, the probability of a motor overheating in a heat wave depends on many design characteristics. Since these characteristics cannot be known by the tool, a probability of overheating could in future be derived based on a large sample of historical experience.

The point at which some elements fail when exposed to a hazard will usually change from asset to asset depending on its materials and the MFCs for that material. Thus with a material specified for the element (as retrieved from the Object Matrix databases) the tool is able to calculate the level of each hazard at which the element will fail, otherwise referred to as the failure threshold.

In some cases a failure thresholds may be associated with design issues rather than a material. For example the failure threshold for electrical elements in floodwater is associated with the height of the water, and more specifically if the water level breaches the floor height of the civil structure.

### Point-in-Time Asset Definitions

FIG. 2B illustrates a method 210 according to one embodiment, also being a computer implemented method for performing risk analysis for a system including a plurality of physical assets. For example, this method may be performed by platform 140 in respect of assets 110.

Functional block 211 represents a process including providing an interface for enabling creation and/or modification of asset data items. For example, this may be a user interface that provides components for enabling a user to view an asset data item, and set/modify data attributes associated with that asset data item at time points.

Functional block 212 represents a process including receiving user input. For example, in respect of a given data item the interface enables a user to:
(i) input current attributes for the asset data item from databases;
(ii) input a future date; and
(iii) input future attributes for the asset data item for the future data (one or more of the future attributes are different from one or more of the current attributes).
(iv) input scenario settings to be tested.

By way of example, a user might observe that a certain road is currently a dirt road, but in year 20XX it will be replaced by asphalt, or note that an electrical system that is currently powered by a remote power plant will in 20YY time be upgraded to derive power from a local solar system. In this manner, the same asset data item is able to account for, specify or test the impact of various changes in an asset over time (and/or its constituent elements and components) over a period of time.

Functional block 214 represents a process including operating a risk assessment engine thereby to perform a risk assessment for the system, taking into account point-in-time data attribute values. That is, the risk assessment takes into consideration the attributes for each asset data item and a set of future conditions parameters for the specific location of the asset. In a case where assuming that the risk assessment is for a time period including the future date, for a given data item the risk assessment is based upon the current attributes for a time period preceding the future date, and based upon the future attributes for a time period following the future date.

Preferably attributes are able to be modified for a plurality of future dates, for example allow for a staggered upgrade cycle, and/or to enable the risk assessment to account for or model proposed future modifications, replacements or upgrades of a given asset.

In some the future date is defined by reference to an event, rather than a specific date. For example, the date may be defined by reference to a measurement or value defined elsewhere in the computer? system. For instance, a future date may be tied to a sea level measurement (i.e. the future date is defined by “when sea level value X equals Y”). This enables modelling based on reactionary modifications to assets. In that regard, such technology enables planning contingent upon taking certain steps to upgrade or otherwise modify assets in response to observed conditions, without necessarily knowing from the outset when those conditions will physically be realised.

### Collaborative Framework Model

In some embodiments, the arrangement of FIG. 1 is implemented via a collaborative cloud-based model whereby a plurality of users contribute to data items 130 and data sources 130, with that contribution being made available to a plurality of other users for risk assessment using platform 140. For example:
A first user defines and uploads data items relating to a first group of assets, and performs sick analysis via platform 140 in respect of those assets;
A second user defines and uploads data items relating to a second group of assets, and performs sick analysis via platform 140 in respect of those assets Discussion about collaborative framework and “pay for privacy” approach;
A third user provides a data source which is configured to be accessed by platform 140; and
A fourth user performs a risk assessment based which leverages some or all of the data items relating to the first group of assets, some or all of the data items relating to the first group of assets, and the data source provided by the third user.

In this manner, a collaborative framework is provided whereby users provide content with which to enhance risk assessment simulations, with that content becoming available to all other users. In some cases incentive to provide such content stems from free (or low-cist) provision of platform 140.

In some embodiments, the collaborative framework in monetised using a “pay for privacy” model. Under this model, a first subset of users pay a first tariff (optionally zero-cost) to use framework 140, but all data items and the like they define become available to other users, and a second subset of users pay a second tariff (a non-zero tariff) to maintain respective private access over data items they define and upload (i.e. those data items are not bade available to other users). This allows a given user to, for a premium, operate framework 140 using a certain set of their own data items which might be viewed as better quality than freely available data items. For instance, this may be used by risk assessment consultants thereby to provide a value-add service in the context of operating framework 140 for clients.

### Exemplary Client-Server Arrangement

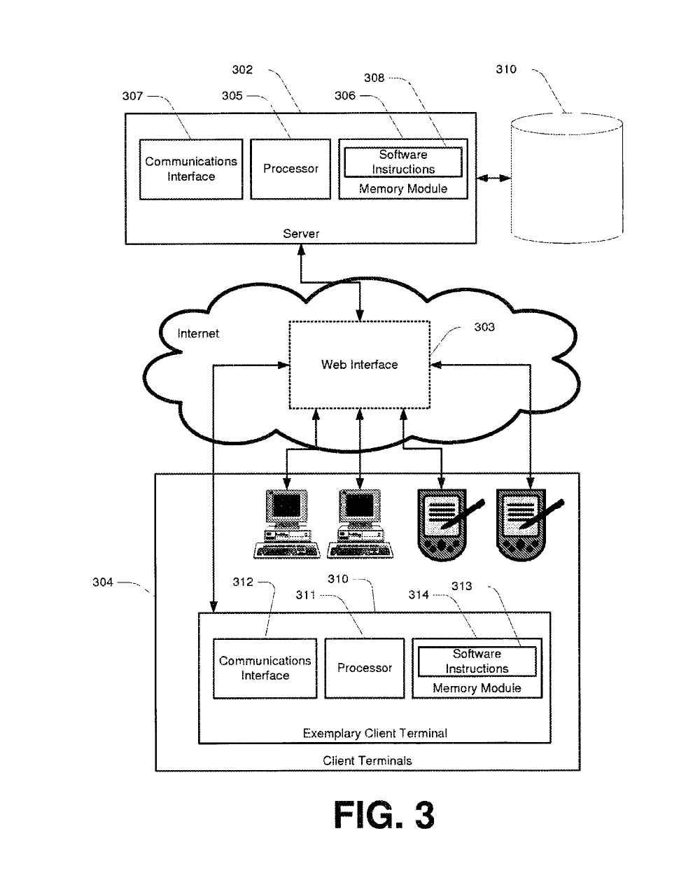

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided to configure and trigger the computational points of the tool on the main (non-chart) server.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

### Conclusions and Interpretation

It will be appreciated that the disclosure above provides various significant to computer implemented frameworks and methodologies for enabling risk analysis for a system comprising a plurality of physical assets.

Unless specifically stated otherwise, as apparent from the following discussions, it is appreciated that throughout the specification discussions utilizing terms such as “processing,” “computing,” “calculating,” “determining”, “analysing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fibre optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for performing risk analysis for a system including a plurality of physical assets, the method including:
for each asset, defining an asset data item;
for each asset data item, defining one or more element data items respectively indicative of elements that constitute the asset;
for each element data item, defining one or more engineering-level data items respectively indicative of materials and components that constitute the element;
disaggregating each asset data item into its constitute element data items, and each element data item into its engineering-level data items;
operating a risk assessment engine thereby to determine risk quantifiers for each of the engineering-level data items based on a set of engineering data parameters and a set of future conditions parameters; and
upwardly aggregating the determined risk quantifiers thereby to determine risk quantifiers for the elements, and upwardly aggregating the risk quantifiers for the elements thereby to determine risk quantifiers for the assets.

2. A method according to claim 1 wherein at least one engineering-level data item is a materials data item, and wherein for the materials data item the engineering data parameters are indicative of performance of a given material under predefined conditions.

3. A method according to claim 1 wherein, for at least one engineering-level data item, the engineering data parameters are indicative of a design envelope representing performance of a given component under predefined conditions.

4. A method according to claim 3 wherein the given component is defined by a structural component, mechanical component, electrical component, or combination of two or more of a structural component, mechanical component, and electrical component.

5. A method according to claim 3 wherein the design envelope represents performance of the engineering-level data item when exposed to one of more hazards or contextual parameters.

6. A method according to claim 1 including, for each element data item, defining one or more sub-elements which comprise the element which may be either discrete physical items or integrated and inseparable from other sub-elements.

7. A method according to claim 1 wherein the risk assessment engine is configured to determine probability of both damage and failure of each of the engineering-level data items when exposed to hazards to which the asset is to be exposed based on the application of a set of engineering data parameters within applied risk algorithms.

8. A method according to claim 1 wherein the risk assessment engine is configured to determine the probability that an asset will be exposed to a hazard event in each time step for a plurality of time steps.

9. A method according to claim 1 including applying asset-specific element exposure matrices to the probability that each element within an asset will be exposed to a hazard if the asset itself is exposed to the hazard.

10. A method according to claim 1 wherein, for each asset, the constituent element items are selected from the group including: civil, electrical, mechanical, electronic, chemical, biological, and ecological.

11. A method according to any preceding claim wherein for a given asset the constituent elements include elements selected from the group created for the archetypes including: power, information, water, and access.

12. A method according to claim 1 wherein:
one or more of the asset data items, element data items and engineering-level data items include a first attribute value that is associated with a first date range, and a second attribute value that is associated with a second date range, and wherein the risk assessment is for a time period including at least a portion of the first and second date ranges, such that the risk assessment is based upon the first attribute value for portion of the time period overlapping with the first date range, and based upon the second attribute value for portion of the time period following overlapping with the second date range.

13. A method according to claim 1 wherein the risk assessment engine is configured to combine risks of asset items based on predefined asset dependence relationships.

14. A method according to claim 1 wherein the risk assessment engine is configured to combine risks of asset items based on predefined inter asset or inter element dependence relationships.

15. A computer implemented method for performing risk analysis for a system including a plurality of physical assets, the method including:
providing an interface for enabling creation of asset data items for each physical asset wherein each data item is defined by a set of attributes describing the asset;
in respect of a given data item:
enabling the user to input current attributes for the asset data item;
enabling the user to input a future date; and
enabling the user to input future attributes for the asset data item for the future data, wherein one or more of the future attributes are different from one or more of the current attributes; and
operating a risk assessment engine thereby to perform a risk assessment for the system, wherein the risk assessment takes into consideration the attributes for each asset data item and a set of future conditions parameters;
wherein the risk assessment is for a time period including the future date, and wherein for the given data item the risk assessment is based upon the current attributes for a time period preceding the future date, and based upon the future attributes for a time period following the future date.

16. A method according to claim 15 wherein steps (i) to (iii) are repeatable for a plurality of future dates.

17. A method according to claim 15 wherein defining a future attribute enables the risk assessment to account for or model proposed future modifications, replacements or upgrades of a given asset.

18. A method according to claim 15 wherein the future date is defined by reference to a trigger event.

19. A method according to claim 18 wherein the trigger event is defined by a data field being modified to contain a predefined value.

20. A method according to claim 15 including enabling a user to select future projections for contextual parameters.

21. A method according to claim 15 wherein a given asset item is associated with one or more constituent element items, and wherein the attribute for which a future attributes are defined are associated with a given one of the element items.

22. A method according to claim 6 wherein the risk assessment engine is configured to combine risks of asset items based on predefined asset dependence relationships.

23-27. (canceled)
